(19) United States
(12) Patent Application Publication
(10) Pub. No.: US 2021/0214626 A1
(43) Pub. Date: Jul. 15, 2021

(54) Method and System for Extracting Methane Gas, Converting it to Clathrates, and Transporting it for Use

(71) Applicant: Michael KEZIRIAN, Seabrook, TX (US)

(72) Inventor: Michael KEZIRIAN, Seabrook, TX (US)

(21) Appl. No.: 17/020,301

(22) Filed: Sep. 14, 2020

Related U.S. Application Data
(60) Provisional application No. 62/899,632, filed on Sep. 12, 2019.

(51) Int. Cl. C10L 3/10; C10L 5/36; B01J 12/00; B01J 31/02

(52) U.S. Cl. CPC C10L 3/108; C10L 5/363; C10L 2270/10; B01J 31/02; C10L 3/104; B01J 12/00

(57) ABSTRACT

Methods and systems for extracting natural gas are described herein. The source of the natural gas may be a reservoir of natural gas or natural gas and crude oil found on land or in a subterranean or subsea environment. The natural gas also may be that extracted from a subsea reservoir of naturally formed clathrate hydrate. The methods may be performed on land, at the sea surface or at the seafloor. The methods feature providing a suitable promoter to facilitate selective formation of a structure II (sII) methane clathrate hydrate to thereby store natural gas in a readily transportable form. The methods may also feature separating both natural gas and associated water involved in producing it from impurities.

### FIELD OF THE DISCLOSURE

The present disclosure relates to extracting and processing natural gas. The source of the natural gas may be a subterranean or a subsea reservoir of natural gas or natural gas and crude oil, or the natural gas that has been extracted from a reservoir of a naturally formed clathrate hydrate. The present disclosure also relates to separating both natural gas from impurities and associated water from impurities. The present disclosure further relates to retrofitting a crude oil production system to obtain, transport and use natural gas.

### BACKGROUND

Methane and other volatile gases separated during the production of crude oil are frequently burned off (or flared) because they cannot be processed by traditional means.

Standard methods for the transportation of natural gas include pumping as a gas through a pipeline or transporting in a container as compressed natural gas (CNG) or liquefied natural gas (LNG). A pipeline is a physical pipe which connects the source of natural gas and the desired destination for the natural gas. Energy is required to pump natural gas through the pipeline. In CNG systems, the natural gas is compressed and stored in a pressurized container for transportation. Energy is required to compress the natural gas and to maintain the pressure during transportation. At the destination, the gas is expanded for subsequent utilization or integration into a natural gas distribution system.

In LNG systems, the natural gas temperature is lowered to about −161° C. at which temperature the gas condenses to a liquid. The LNG is stored in a specialized container (with insulation and/or vacuum barrier to minimize heat transfer) for transportation. At the destination, the gas temperature is increased, and the gas expands for subsequent use or integration into a natural gas distribution system. Energy is required to liquefy natural gas and maintain the gas temperature and pressure during transportation. With LNG the reduction in volume is approximately a factor of 600 compared with the same quantity of natural gas at standard temperature and pressure.

Transporting natural gas as LNG has become an industry-preferred solution. One drawback of the system is that there is an economy of scale. There must be a very large production volume for the system to be economical. In other words, at small production rates, the necessary infrastructure costs do not correspond to a viable economic model where an investment yields a profitable system. There are currently, in production and in operation, terminals around the world that convert natural gas to LNG for transport, both on land and on the sea. There are also terminals which operate to convert LNG back to natural gas.

There are a number of factors that influence the decision of whether to produce a reservoir containing natural gas. If the reservoir does not meet certain criteria, then the natural gas contained therein is deemed as stranded natural gas, and it is not produced for consumption. A stranded gas reservoir is therefore understood as a natural gas field that has been discovered but remains unusable for either physical or economic reasons. A natural gas reservoir may be considered stranded because the quantity of natural gas is too small, because it is too difficult to reach, or because it is geographically removed from a market for the energy. Also, a reservoir may be deemed stranded if the natural gas contains too many impurities by percentage composition. These impurities may include, for instance, carbon dioxide, hydrogen sulfide, water vapor, and nitrogen.

Chinn, U.S. Patent Publication 2014/0100295 teaches converting CO₂ into a synthetic fuel by reacting it with certain chemicals to provide a valuable product from this greenhouse gas with no value. In this manner, stranded gas fields with high CO₂ could become economic to produce.

Heinemann, U.S. Pat. No. 6,028,234 teaches production of naturally occurring clathrates, e.g. marine sediments of clathrates. Initially, electric heaters are placed in the marine sediment so heat can be applied to dissociate the hydrate and produce natural gas. It subsequently will reform hydrate as transfer to the surface is attempted. The subsequent methods involve schemes to direct heat through transfer from subsequent cascading forming and dissociating of hydrate, directing sunlight, radiation and other forms.

Watanabe, U.S. Patent Publication 2010/0325955 teaches making almost almond shaped hydrate pellets (tubular form) and packing the hydrate pellets in containers to retain discrete objects and to keep the temperature low so as to prevent agglomeration. Watanabe may be analogized to producing ice cubes instead of powdered ice (or snow) but retaining the ice cubes as the cubes they are without solidifying the ice cubes into a large block.

Zhang, U.S. Patent Publication 2008/0135257 teaches mining a marine sediment hydrate by heating the naturally formed hydrate to form natural gas. Zhang in essence collects gas that is released. In so doing, Zhang recognizes that the conditions where hydrates form naturally are indeed the conditions which would lead to hydrate formation in subterranean environments (i.e. at the conditions on the seafloor). Hence, according to the teachings of Zhang, hydrates reform because as the hydrates rise to the surface of the sea, the hydrates subsequently dissociate to form natural gas. Zhang merely teaches allowing the natural gas to subsequently reform hydrates knowing the hydrates will later dissociate. Jones, U.S. Patent Publication 2010/0048963 teaches producing hydrate reservoirs from a plurality of hydrocarbon reservoirs with at least one conventional hydrocarbon reservoir. The excess heat in the production of the conventional reservoir is used as the source of heat to dissociate and hence produce the natural gas from the natural gas hydrate reservoir.

It would be beneficial to provide methods and systems suitable for extracting natural gas including those that are deemed stranded and transporting the natural gas in an economic and energy efficient manner. It would also be beneficial to be able to use the water that is generated from the production of natural gas by separating water from the impurities. Similary, it is necessary to separate natural gas from impurities.

### SUMMARY

In a first aspect, methods for extracting natural gas from a reservoir are provided. Natural gas is a gas consisting largely of methane and other hydrocarbons. The reservoir may contain natural gas, crude oil (which is a mixture of oil and natural gas), or the reservoir may be natural gas stored as a natural gas clathrate hydrate (NGCH). The methods feature an optional first step of drilling a well to reach the reservoir. If the reservoir is natural gas, then the contents are ready to be transported. In the instances where the reservoir is crude oil, the methods feature a second step of separating the oil and the natural gas. The methods may feature a third step of transporting, pumping or piping the oil component for processing according to known methods. Similarly, the third step may feature collecting the oil component into separate shipping containers for suitable transport. In yet other instances, the stranded natural gas may exist in the form of a natural gas clathrate hydrate (NGCH). In such instances, the second step may include dissociating the original natural gas clathrate hydrate (NGCH) into gas and water by, for instance, applying heat or lowering the pressure or both. In all instances, the methods may feature a fourth step of cleaning the natural gas of debris. The methods may feature a fifth step of transporting, pumping or piping the natural gas into a gas/clathrate hydrate processing facility, such as one proximate on the seafloor. The gas/clathrate hydrate processing facility may be designed to transform the natural gas such that it forms natural gas clathrate hydrate (NGCH).

A promoter may be provided to facilitate transformation of the natural gas into a structure II (sII) hydrate. The transforming of natural gas so that it forms natural gas clathrate hydrates (NGCH) may result in separation of impurities from the natural gas such as CO₂. The impurities including CO₂ may then be pumped back into the reservoir to maintain the pressure of the reservoir and to reduce or avoid release of CO₂ into the atmosphere. As a sixth step, such solid natural gas clathrate hydrates (NGCH) may be assembled and placed into shipping containers suitable for transporting. In some instances, the solid hydrates such as natural gas clathrate hydrates are first assembled and placed into shipping containers that are then emptied at the sea surface into a larger transport carrier for transport to a destination for conversion back to natural gas or re-gasification. In other instances, the solid natural gas clathrate hydrates are assembled and placed into shipping containers, and these shipping containers are themselves used to transport the natural gas clathrate hydrates (NGCH) to a destination for re-gasification, i.e. conversion back to natural gas.

In an alternative sixth step, the solid hydrates may be transported to the sea surface and then to a target destination such as a terminal either at a port or floating in the sea, i.e. a Floating Liquefied Natural Gas (FLG). There it may be dissociated to water and natural gas and then further processed, according to known techniques to, for instance, liquefied natural gas (LNG).

The natural gas reservoir may be found on land or in the sea such as, for instance, at the seafloor. The transporting, pumping or piping of the natural gas into a gas/clathrate hydrate processing facility may be performed at any depth from the seafloor to the surface of the sea. The gas/clathrate hydrate processing facility designed to transform the natural gas so that it forms solid natural gas clathrate hydrates (NGCH) may be found at the seafloor, at the surface of the sea, such as, for instance on an oil platform or proximate to an oil platform, or on land, such as, for instance, proximate a crude oil well.

In a second aspect, methods are described herein for extracting natural gas from a reservoir of natural gas hydrates, such as those that may be found in a subterranean environment such as at the seafloor. The methods feature an optional first step of drilling a subsea well to extract the hydrocarbons. In some instances, depending upon the hydrocarbon makeup of the reservoir, the well may yield natural gas only. The methods may feature a second step of cleaning the natural gas of debris. The methods may feature a third step of transporting, pumping or piping the natural gas into a gas/clathrate hydrate processing facility. The gas/clathrate hydrate processing facility may be found at or proximate to the seafloor, at or proximate to the sea surface, or on land. The gas/clathrate hydrate processing facility may be designed to transform the natural gas so that it forms solid hydrates such as clathrate hydrate. A promoter may be provided to facilitate transformation of the natural gas into a structure II (sII) hydrate. Heat generated from this exothermic process of transforming the natural gas so that it forms a natural gas clathrate hydrate may optionally be conducted or convected back to the source of the natural gas and subsequently used to facilitate liberating additional natural gas. As a fourth step, such solid natural gas clathrate hydrates may be assembled and placed into shipping containers suitable for transporting the solid natural gas clathrate hydrates to the sea surface. In some instances, the natural gas clathrate hydrate are first assembled and placed into shipping containers that are then emptied at the sea surface into a larger transport carrier for transport to a destination for conversion back to natural gas. In other instances, the solid natural gas clathrate hydrates are assembled and placed into shipping containers, and these shipping containers are themselves used to transport the natural gas clathrate hydrate to a destination for conversion back to natural gas. In an alternative fourth step, the solid natural gas clathrate hydrates may be transported to the sea surface and dissociated to water and natural gas according to known techniques. The natural gas may then be processed further according to known techniques to, for instance, liquefied natural gas (LNG).

The methods involve converting stranded gas such as natural gas to form natural gas clathrate hydrates and may result in liberation of impurities from the natural gas such as CO₂. The CO₂ may then be pumped back into the reservoir from whence it came, for instance a subterranean or subsea reservoir to maintain reservoir pressure and avoid entry into the atmosphere of CO₂.

In a third aspect, the invention provides a method for extracting natural gas or a mixture of oil and natural gas from a subterranean environment such as beneath the seafloor and converting it into a solid hydrate such as a clathrate comprising:
a) extracting natural gas or a mixture of oil and natural gas;
b) optionally separating the natural gas from the mixture of oil and natural gas in a first tank or vessel;
c) transporting the natural gas to a second tank or vessel;
d) introducing sea water into the second tank or vessel;
e) providing a promoter;
f) mixing the natural gas and water to form a NGCH/water slurry;
g) removing excess water from the NGCH slurry to form a solid comprising a clathrate; and
h) processing the solid comprising a clathrate into a transportable form.

The methane clathrate hydrate may be transferred to a vessel for storage and transportation. The ideal characteristics of the vessel are 1) neutrally or near-neutrally buoyant (i.e. the same or similar density as the external fluid or sea water), 2) strong (to contain the material without leaking contents or rupturing) and 3) flexible so that it would not contain much or any void volume as the vessel is filled. The vessel may be suitable to sustain a pressure differential so that the internal pressure may be maintained in order for the contained clathrate hydrate to remain in the stability region (i.e. remain as a hydrate rather than prematurely dissociate to a natural gas and water). In some instances, the pressure vessel is flexible so that the volume expands as it is filled. In other instances, the vessel is rigid but filled with water or other inert fluid that may be emptied as the clathrate hydrate is loaded into the vessel. In such instances, the vessel may contain a bladder or diaphragm to separate the hydrate clathrate from the water or other inert fluid. Such a bladder or diaphragm is a common feature used frequently in the aerospace industry to prevent mixing between two species such as a liquid fuel and an inert gas used to maintain the pressure of the vessel.

The processing of the solid comprising a clathrate into a transportable form may feature molding or shaping the solid into a suitable size and shape for transport or may feature dissociating the clathrate to water and natural gas according to known techniques. The natural gas may then be processed further according to known techniques to, for instance, liquid natural gas (LNG).\

The methods involve converting natural gas to form solid hydrates such as clathrates and may result in liberation of impurities from the natural gas such as CO₂. The CO₂ may then be pumped back into the subterranean environment or reservoir to avoid release into the atmosphere.

In a fourth aspect, described herein is a system for extracting natural gas or a mixture of oil and natural gas from a reservoir, such as beneath the seafloor, and converting it into a solid hydrate such as a clathrate featuring the following:
a) a first tank or vessel designed to function as a gas/oil separator;
b) a second tank or vessel designed to function as a NGCH processor; and
c) a third tank or vessel adapted to function as a NGCH Collection/Shipping container.

The system may optionally comprise d) a well-head entry, and the system may optionally comprise e) a turbine/flow restrictor that may be coupled to a flow restrictor. a first tank or vessel designed to function as a gas/oil separator. The turbine may be attached to the exit of the well head to generate mechanical and electrical power to run electric motors and mechanical processing devices.

The first tank or vessel designed to function as a gas/oil separator or gas/oil/water separator by traditional means. The separator may operate as a cyclone where heavier (primarily oil) particles physically separated from the lighter (primarily gas) particles. In three phase separations where there is a large quantity of water, beyond what is needed for production, the excess water may be pumped into a disposal well.

The second tank or vessel designed to function as a NGCH processor may operate at the local pressure or it may operate at a higher pressure. The second tank or vessel may be designed to operate as a continuous or batch process. In some instances, there may be multiple (e.g. 3) smaller batch processing tanks or vessels, Tank 2a, Tank 2b, Tank 2c, etc. staggered in time to accommodate larger residence times in the Tank 2 stage and provide for continuous production from the reservoir. The second tank or vessel may be semi flexible and may feature a valved top inlet and/or a bottom outlet. Each tank may contain diagnostic and control sensors (i.e. for temperature, pressure, composition). There may also be one or more apparatuses to provide for mixing.

The third tank or vessel may be adapted to function as a NGCH Collection/Shipping Container The ideal characteristics of the container are 1) neutrally or near-neutrally buoyant (i.e. the same or similar density as the external fluid or sea water), 2) strong (to contain the material without leaking contents or rupturing) and 3) flexible so that it would not contain any void volume as the vessel is filled. The vessel may sustain a pressure differential so that the internal pressure may be maintained in order for the contained clathrate hydrate to remain in the stability region (i.e. remain as a hydrate rather than prematurely dissociate to a natural gas and water). In some instances, the pressure vessel may be flexible so that the volume may expand as it is filled. In other instances, the vessel is rigid but filled with water or other inert fluid that is emptied as the clathrate hydrate is loaded into the vessel. In such instances, the vessel may contain a bladder or diaphragm to separate the hydrate clathrate from the water or other inert fluid. Such a bladder or diaphragm is a common feature used frequently in the aerospace industry to prevent mixing between two species such as a liquid fuel and an inert gas used to maintain the pressure of the liquid fuel.

In a fifth aspect, the methods and systems described herein provide for separating CO₂ and other impurities from natural gas present in the reservoir. Such undesired gases may be captured and sequestered. The methods may be performed so that release of CO₂ into the atmosphere is minimized. When applied to a reservoir of natural gas or natural gas and crude oil, the CO₂ pumped back into such reservoir may thereby increase internal pressure of the same and hence provide for greater efficiency in extracting the remaining reservoir. CO₂ does not form an sII clathrate hydrate according to the methods and systems described herein. As such, CO₂ may effectively be separated from natural gas.

In a sixth aspect, the methods and systems described herein provide methods for producing usable water. The methods feature forming a natural gas clathrate hydrate according to any of the methods described herein and subsequently processing the natural gas clathrate hydrate to release the natural gas. The water generated from the artificially formed natural gas clathrate hydrate may be substantially free of impurities inherent in the original source. The water produced thereby may be further processed, as necessary, for subsequent use, such as, for instance, as industrial ‘grey’ water or as potable water.

### BRIEF DESCRIPTION OF THE DRAWINGS

FIGS. 1A and 1B provide phase equilibrium curves (boundaries) for formation of clathrate hydrates from methane (FIG. 1A), and equilibrium curves for natural gas containing other volatile hydrocarbons. The curves depict the hydrate/gas phase boundaries of pure methane and a methane/hydrocarbon admixture at various temperatures and sea depths. Also shown are temperature isoclines for the Gulf of Mexico and the North Sea.

FIG. 2 depicts hydrate equilibrium data for both a structure I (sI) methane clathrate hydrate and a structure II (sII) methane clathrate hydrate. The sI is for a methane/water system and the sII is from a methane/THF/water system.

FIG. 3 depicts the presently described methods and systems for forming a structure II (sII) methane clathrate hydrate.

FIG. 4 depicts instances of the presently described methods and systems where parallel streams for stable methane clathrate formation are provided.

FIG. 5 depicts the retrofitting of the presently described methods and systems to an oil production facility.

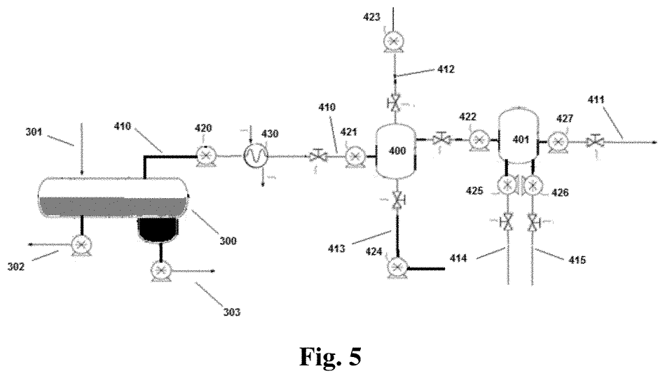

FIG. 6 also depicts the retrofitting of the presently described methods and systems to an oil production facility.

FIG. 7 is a schematic of a system to process natural gas obtained from the dissociation of clathrate hydrates that naturally occur at or below the seafloor. The method optionally provides the opportunity to direct latent heat that is produced from the formation of artificial hydrates to enhance dissociation of natural gas in the reservoir.

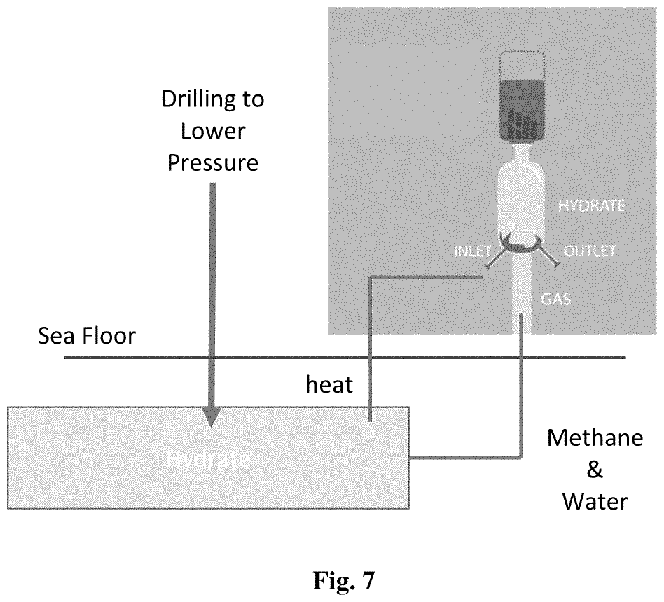

FIG. 8 depicts the retrofitting the methods and systems described herein to an existing off-shore production facility where the natural gas is currently being flared. Instead, the natural gas is directed to the surface or below the surface of the sea for subsequent processing for storage and transport. A portion of the natural gas can be flared to generate energy to operate the process and to permit the disposal of unwanted impurities.

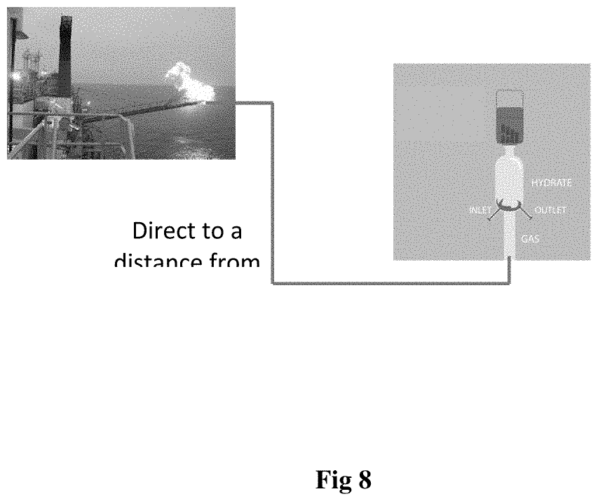

FIG. 9 is a notional diagram where a hydrate is converted to natural gas for subsequent processing to liquid natural gas (LNG) at a floating offshore production and offloading vessel (FSPO). Alternatively, the product can be shipped to an LNG terminal at a port location for processing to LNG.

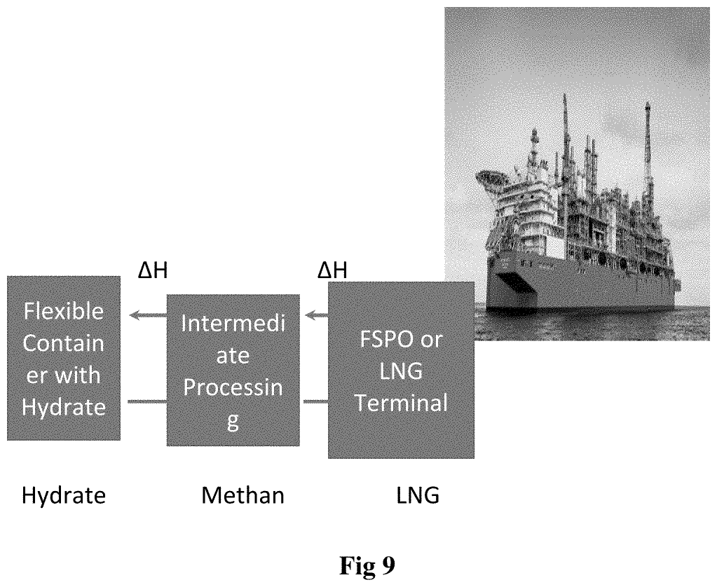

### DETAILED DESCRIPTION

The materials, compounds, compositions, articles, and methods described herein may be understood more readily by reference to the following detailed description of specific aspects of the disclosed subject matter and the Examples included therein.

Before the present materials, compounds, compositions, and methods are disclosed and described, it is to be understood that the aspects described below are not limited to specific synthetic methods or specific reagents, as such may, of course, vary. It is also to be understood that the terminology used herein is for the purpose of describing particular aspects only and is not intended to be limiting.

### General Definitions

In this specification and in the claims that follow, reference will be made to a number of terms, which are defined to have the following meanings:

All percentages, ratios and proportions herein are by weight, unless otherwise specified. All temperatures are in degrees Celsius (° C.) unless otherwise specified.

The terms “a” and “an” are defined as one or more unless this disclosure explicitly requires otherwise.

Ranges may be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

“Optional” or “optionally” means that the subsequently described event or circumstance can or cannot occur, and that the description includes instances where the event or circumstance occurs and instances where it does not.

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, an apparatus that “comprises,” “has,” “includes” or “contains” one or more elements possesses those one or more elements but is not limited to possessing only those elements Likewise, a method that “comprises,” “has,” “includes” or “contains” one or more steps possesses those one or more steps but is not limited to possessing only those one or more steps.

Any embodiment of any of the methods can consist of or consist essentially of—rather than comprise/include/contain/have—any of the described steps, elements, and/or features. Thus, in any of the claims, the term “consisting of” or “consisting essentially of” can be substituted for any of the open-ended linking verbs recited above, in order to change the scope of a given claim from what it would otherwise be using the open-ended linking verb.

The term “stranded” gas reservoir is defined herein as a natural gas reservoir that is known but remains unusable for either physical or economic reasons.

The term “natural gas” is defined herein as both the final product, i.e., methane and the crude material which is obtained from natural sources. The term “natural gas” includes methane and higher order desirable hydrocarbons, and oil as having hydrocarbons that form a liquid, though not a gas at standard pressure. The term “crude natural gas” is used interchangeably with “natural gas.” Crude natural gas comprises, inter alia, methane, as well as, other hydrocarbons and gases such as carbon dioxide, nitrogen, hydrogen sulfide, helium, and the like.

The terms methane hydrate, methane clathrate and methane hydrate clathrate are used interchangeably. The terms for methane hydrate clathrate and natural gas hydrate clathrate are also used interchangeably unless specifically indicating a difference. References to a type I or structure I (sI) clathrate are used interchangeably. Similarly, the term for a type II or structure II (sII) clathrate are used interchangeably with one another.

The feature or features of one embodiment described herein may be applied to other embodiments, even though not described or illustrated, unless expressly prohibited by this disclosure or the nature of the embodiments.

### Applicability of the Methods and Systems

Described herein are methods and systems for producing natural gas from the environment. The methods described herein provide for artificially forming a natural gas clathrate hydrate for the purposes of recovering, storing and transporting natural gas. Gas clathrate hydrates are nonstoichiometric crystalline solids formed from the reaction of water and gas under certain conditions of relatively high pressure and low temperature. (See, e.g. Sloan et al., Clathrate Hydrates of Natural Gases. 3rd ed.; CRC Press, Taylor & Francis Group: Boca Raton, Fla., 2008).

The methods and systems described herein enable extracting natural gas using methods that are economical from a cost and energy balance perspective. The methods and systems described herein require less energy to produce natural gas compared to the stored potential energy in the natural gas that is extracted. The methods described herein enable producing natural gas from reservoirs that are otherwise unusable and, therefore, regarded as “stranded.” The source of the natural gas may be a subterranean or a subsea reservoir of petroleum that can be either natural gas or a combination of natural gas and crude oil. The source may also be the natural gas that has been extracted from a subsea reservoir of naturally formed clathrate hydrates. The methods and systems described herein also provide for retrofitting a production system of petroleum.

The methods and systems described herein can be adapted to further capture and separate higher molecular weight volatiles, for example, ethane, propane, butane and pentanes. This can be achieved by allowing a change in temperature and pressure in a processing vessel such that species with different hydrate formation conditions form solid gas clathrate hydrate. The gases may be isolated by conventional methods such as distillation or by cold-finger condensation.

The methods and systems described herein may be adapted to capture natural gas that has been harvested from naturally formed natural gas hydrate clathrate reservoirs such as those formed in the deep sea or sub-permafrost. These clathrates may also contain impurities, including carbon dioxide. The methods and systems may be utilized to remove such impurities.

Crude oil comprises natural gas. The methods and systems described herein are useful for extracting natural gas from a source of crude oil. As further described herein, the method and systems may be performed at the subsea level, on the seafloor, at an intermediate level, at the sea surface, or on land. The methods and systems described herein may be adapted to the composition and amount of natural gas in the crude oil.

The methods and systems described herein provide for separating natural gas and oil at a well head, processing the resulting natural gas into solid natural gas clathrate hydrate (NGCH), and filling shipping containers with the solid NGCH for transport, such as, for instance, for transport to the sea surface and for transport to distant facilities for reconverting the solid NGCH to natural gas. The methods and systems described herein include the overall processing system design and the materials used, as well as the transport container design and materials used.

### Embodiments of the Methods and Systems

In some instances, the methods and systems for recovering methane from crude oil described herein feature the following:
a) receiving crude oil into a first vessel in an amount to create a head space;
b) adjusting temperature and/or pressure of the vessel;
c) separating dissolved gases from the vessel;
d) transferring the separated gases into a second vessel;
e) introducing service water or ingested sea water into the second vessel;
f) providing a promoter and optionally a surfactant into the second vessel in an amount sufficient to form a clathrate slurry; and
g) transferring the slurry to a third vessel to form a stable sII methane clathrate hydrate.

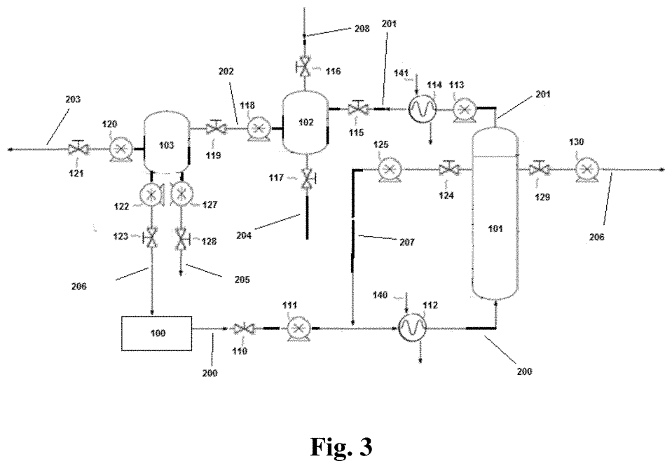

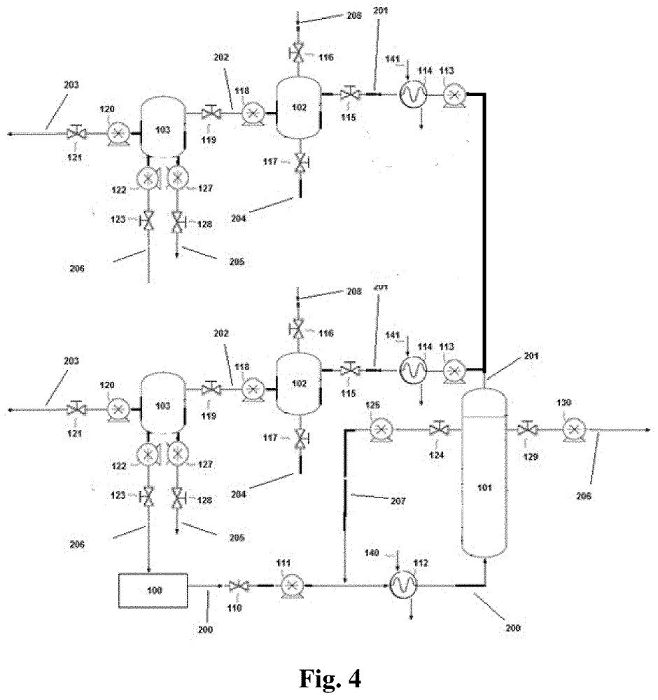

The methods described herein can be conducted on a batch scale as described herein and depicted in FIG. 3. Alternatively, the methods can be adapted to be a continuous process as depicted in FIG. 4 by placing one or more vessels 2 (102) and 3 (103) in parallel. Once the stable methane clathrate hydrate is suitably formed it can be transferred to a container for transport to facility for use or to a facility wherein the clathrate further processed.

Once the methane clathrate hydrate has been removed following g), the methods may feature the following optional additional steps:
h) transferring the processed crude oil from the first vessel to a container, pipeline, ship, or the like for further processing; and
i) removing any unprocessed gases from the second vessel, i.e., CO₂, other impurities, and volatile hydrocarbons, for example, ethane, propane and butane.

Crude oil from a reservoir may also contain CO₂ as well as other impurities. CO₂ liberated during the methods described herein may be further processed. For example, the gas may be processed into a liquid or a solid form. Alternatively, the gas may be captured by conventional means, such as on an absorbent. This may be performed, for instance, when adjusting the temperature and pressure of the first vessel (101) in subsequent runs.

The promoter provided in step (f) may be contained in water removed from vessel 3 (103). The promoter may be recovered for recycling into the process. For example, THF which is an effective promoter forms a minimum azeotrope with water at 64° C. which contains 6.7% water in mass fraction. In instances where the service water does not contain high amounts of dissolved impurities, i.e., sea water, the THF may be azeotroped to form an aqueous solution high in THF content that may be a suitable source of the promoter. Because formation of the sII hydrate is an exothermic process, the energy released may be used to supplement the energy necessary to recover the promoter. Volatile hydrocarbons can be likewise captured and further treated for use.

In some instances, any CO₂ released may be re-injected back into the reservoir. As such, the methods described herein may feature the following:
a) receiving crude oil into a first vessel in an amount sufficient to create a head space;
b) adjusting temperature and/or pressure of the first vessel to produce separation of dissolved gases;
c) transferring the separated gases into a second vessel;
d) introducing service water or ingested sea water into the second vessel;
e) providing a promoter and optionally a surfactant into the second vessel in an amount sufficient to form a clathrate slurry;
f) removing non-methane gases that do not from a clathrate;
g) transferring the non-methane gases of f) into the reservoir;
h) transferring the clathrate slurry to a third vessel; and
i) reducing the amount of service water present in the third vessel to form a stable sII methane clathrate hydrate.

The CO₂ and other impurities separated from the crude oil in the disclosed process may be directly injected back into the crude oil reservoir. As such, in some instances this features:
a) receiving crude oil into a vessel in an amount sufficient to create a head space;
b) adjusting temperature and/or pressure of the vessel to separate dissolved gases;
c) transferring the separated gases into a second vessel;
d) introducing service water and a promoter into the second vessel to form a clathrate slurry;
e) transferring any CO₂ and other impurities liberated from the crude oil back into the crude oil reservoir; and
f) transferring the slurry to a third vessel and reducing the amount of service water present to form a stable sII methane clathrate hydrate.

In some instances, the methods described herein feature retrofitting to a crude oil production facility. Typically, methane and other volatile gases are contained in a low boiling distillate fraction, for example, a naphtha fraction. This naphtha fraction is allowed to condense so that liquid naphtha is separated from any volatile gases, including lower boiling point hydrocarbons. This gaseous fraction is typically flared or burned off.

As such, the methods may feature the following:
a) receiving volatile gases separated during a refinery process into a first vessel containing service water and a promoter;
b) adjusting temperature and/or pressure of the first vessel to thereby form a methane clathrate slurry;
c) removing volatile gases;
d) transferring the methane clathrate slurry to a second vessel; and
e) removing service water thereby forming a stable sII methane clathrate hydrate.

The stable sII clathrate hydrate thereby formed may be transported. In some instances. the methane clathrate hydrate may be transferred to a vessel for storage and transportation. The ideal characteristics of the vessel are 1) neutrally or near-neutrally buoyant (i.e. the same or similar density as the external fluid or sea water), 2) strong (to contain the material without leaking contents or rupturing) and 3) flexible so that it would not contain any void volume as the vessel is filled. The vessel may sustain a pressure differential so that the internal pressure may be maintained in order for the contained clathrate hydrate to remain in the stability region (i.e. remain as a hydrate rather than prematurely dissociate to a natural gas and water). In some instances, the pressure vessel is flexible so that the volume expands as it is filled. In other instances, the vessel is rigid but filled with water or other inert fluid that is emptied as the clathrate hydrate is loaded into the vessel. In such instances, the vessel may contain a bladder or diaphragm to separate the hydrate clathrate from the water or other inert fluid. Such a bladder or diaphragm is a common feature used frequently in the aerospace industry to prevent mixing between two species such as a liquid fuel and an inert gas used to maintain the pressure of the liquid fuel.

Naturally occurring clathrates may contain CO₂ as well as other impurities. The method and system described herein may enable separating these impurities and reforming substantially pure methane clathrate hydrates. The resulting solid methane clathrate hydrates may be further processed.

In some instances, the methods described herein for collecting methane from a sea bed reservoir feature the following:
a) collecting natural gas or a mixture of crude oil and natural gas in a first containment vessel;
b) transferring the natural gas into a second containment vessel;
c) introducing service water or ingested sea water into the second containment vessel;
d) introducing a promoter and optionally a surfactant into the second vessel;
e) mixing the contents of the second vessel to thereby form a methane clathrate hydrate aqueous slurry;
f) removing excess water from the methane clathrate hydrate aqueous slurry to thereby form a solid methane clathrate hydrate; and
g) transferring the solid methane clathrate hydrate to a container suitable for transport.

In such instances, the methods may also be adjusted to remove any contaminant gases, such as, for instance, sulfur containing gases, as well as CO₂. These contaminant gases may be captured and retained or transferred back to the sea bed reservoir.

In some instances, the methods and systems described herein are for collecting methane from a stream of produced crude oil. The methane may be collected because the solubility of absorbed gases decreases as pressure decreases. Likewise, gases are more soluble in liquids as temperature decreases. The methods described herein for removing hydrocarbon gases from crude oil may feature:
a) collecting crude oil in a first containment vessel having a first temperature and pressure;
b) adjusting the temperature and/or the pressure to dissociate any entrained hydrocarbon gases;
c) transferring the released hydrocarbon gases into a second containment vessel;
d) introducing service water or ingested sea water into the second containment vessel;
e) providing a promoter and optionally a surfactant into the second containment vessel;
f) mixing the contents of the second containment vessel to thereby form a natural gas clathrate hydrate aqueous slurry;
g) removing excess water from the natural gas clathrate hydrate aqueous slurry to thereby form a solid clathrate hydrate.

The methods take advantage of properties of natural gas admixtures to fractionate natural gas into its components. This fractionation may be performed at a site of further processing.

### Sites of Production

The methods and systems described herein may be performed at any location. For example, the system described herein may be located on the seafloor adjacent to or connected to a crude petroleum reservoir. The methods may be performed below sea level but above the seafloor, for example, as a submerged system tethered to an oil rig and modified to interrupt or otherwise capture crude oil before it reaches the rig. In addition, the methods and systems described herein may be performed on land, such as connected directly to an above ground wellhead or at a point in a process (upstream production or at refinery) where natural gas and associated impurities would otherwise be flared.

The methods and systems described herein for forming a solid methane clathrate hydrate may be performed at a land-based facility. In such instances, it may be desirable and necessary to subsequently dissociate the artificially formed methane clathrate hydrate to natural gas and water. Performing the process enables extracting pure water and natural gas that may be utilized rather than discarded. Additionally, it may separate and concentrate impurities in the original water and gas streams for disposal, either flaring or sequestration through conventional methods. The volume of fluid required for disposal may be greatly reduced by applying this method.

In addition, the methods and systems described herein may be adapted to production facilities. For example, methane and other volatile gases separated during the refining process are normally flared or burned off because they cannot be processed by traditional means such as a pipeline, CNG, or LNG methods. As described herein, the volatile gases may be directed into the methods described herein for removal of methane and other gases.

Methane containing crude oil is known to seep out of bore holes along the seafloor. The methane entrained therein either escapes into the atmosphere or is part of a petroleum surface layer. Capture of this crude oil discharge prior to it reaching the surface allows for producing the methane that may be unrecoverable when it reaches the surface and preventing it from escaping into the atmosphere.

Methane clathrate hydrates can form in crude oil reservoirs. The present methods and systems can be used to convert the natural gas in methane clathrate hydrates to stable, shippable sII methane clathrate hydrates.

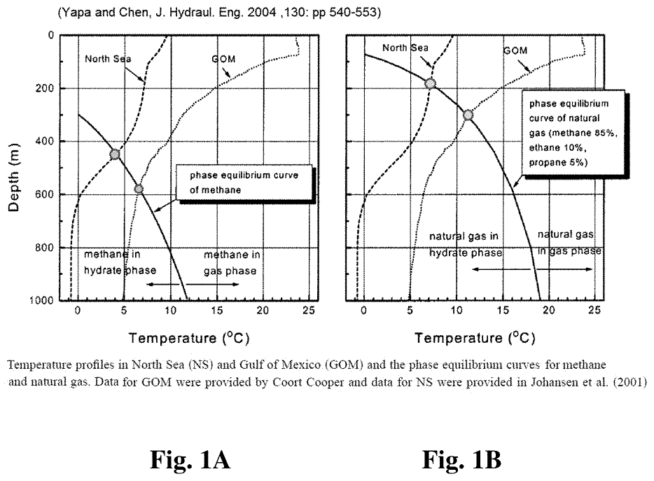

Contained within natural gas clathrates are other short chain hydrocarbons, for example, ethane, propane, butane and isomers of propane and butane. These non-methane clathrate hydrates may be isolated from methane and produced separately. FIG. 1 depicts the phase equilibrium curves (boundaries) for the formation of clathrate hydrates of pure methane, pure ethane, pure propane and pure butane. Without wishing to be limited by theory, by adjusting the temperature and pressure of capture vessels described herein, these non-methane hydrocarbons can be isolated from methane.

Subsea Environment

Presently off-shore oil production facilities frequently flare natural gas that is obtained during production of crude petroleum. It is desirable to develop safe, efficient and environmentally friendly ways of producing natural gas , from land based or from underwater environments and transporting such gases for consumption. Previous processes focus on formation of methane clathrate hydrates (MCH) since methane is the primary component of natural gas. Yet, depending on origin, the range of possible natural gas composition may range from nearly pure methane to complex mixtures, rich in heavier volatile hydrocarbons. The processes described herein more generally refer to formation of natural gas clathrate hydrate (NGCH) where the starting natural gas may be about 85% methane, 10% ethane and 5% propane by mass. The processes may be easily adapted to other compositions. Formation of NGCH from natural gas mixtures generally requires less hydrostatic pressure at the same temperature than the formation of MCH from pure methane (FIG. 1). Also, other less typical or artificially blended hydrocarbon gas mixtures, involving less methane and more ethane, propane, butane and iso-pentane, etc., also form solid clathrate hydrates, and the higher the proportion of these higher molecular weight gas components, the lower the pressure required. However, the temperature range for clathrate formation becomes much narrower and in instances where formation from pure butane requires water temperatures below 4° C., pressures required for clathrate hydrate formation from these pure hydrocarbon gasses.

The seafloor provides an ideal environment to form and process NGCH. There are, however, several technical issues that relate to efficiently converting large quantities of natural gas to natural gas clathrate hydrate. Transporting containers from the seafloor to the sea surface must be capable of maintaining the stability of the NGCH over some time. That is, there should be no significant and premature dissociation of the NGCH into water and natural gas. The methods described herein provide for this without any cumbersome cooling or pressurization systems attached to the containers.

### Transportation and Storage

It is necessary to address the stability of the natural gas clathrate hydrate during transportation and storage until the natural gas is recovered. To maintain stability, the pressure and temperature within a pressurized container are controlled.

### Promoter

Thermodynamic promoters are suitable for use in the methods and systems described herein. Thermodynamic promoters are compounds that alter or shift the equilibrium conditions of methane hydrate formation. The thermodynamic promoters also improve the kinetic rate of formation. One disadvantage of using a thermodynamic promoter is a lower storage efficiency. Adding a thermodynamic promoter for hydrate formation provides more moderate formation conditions (lower pressure and high temperature). The multifold reduction of pressure at more ambient temperatures offsets the observed reduction in storage capacity.

Tetrahydrofuran (THF) is one such suitable promoter that is widely available. Other suitable promoters that facilitate forming a sII hydrate include cyclopentane (CP), 2,2-dimethyl butane (neohexane), methyl cyclohexane (MCH), neohexane, 2-methylcyclohexane, pinacolone, isoamyl alcohol and tertiary butyl methyl ether (TBME). (See, e.g., Veluswamy et al., Applied Energy 2018; 216:262-285)

A chemical promoter is provided in order to facilitate forming a structure II (sII) hydrate under temperature and pressure conditions that are unfavorable for formation of a structure I (sI) hydrate. With the right promoter, the hydrate that is formed is a sII hydrate. Tetrahydrofuran (THF) is a suitable promoter that is widely available. Other suitable promoters that form a sII hydrate include cyclopentane (CP), 2,2-dimethyl butane (neohexane), methyl cyclohexane (MCH), neohexane, 2-methylcyclohexane, pinacolone, isoamyl alcohol and tertiary butyl methyl ether (TBME). (See, e.g., Veluswamy et al., Applied Energy 2018; 216:262-285).

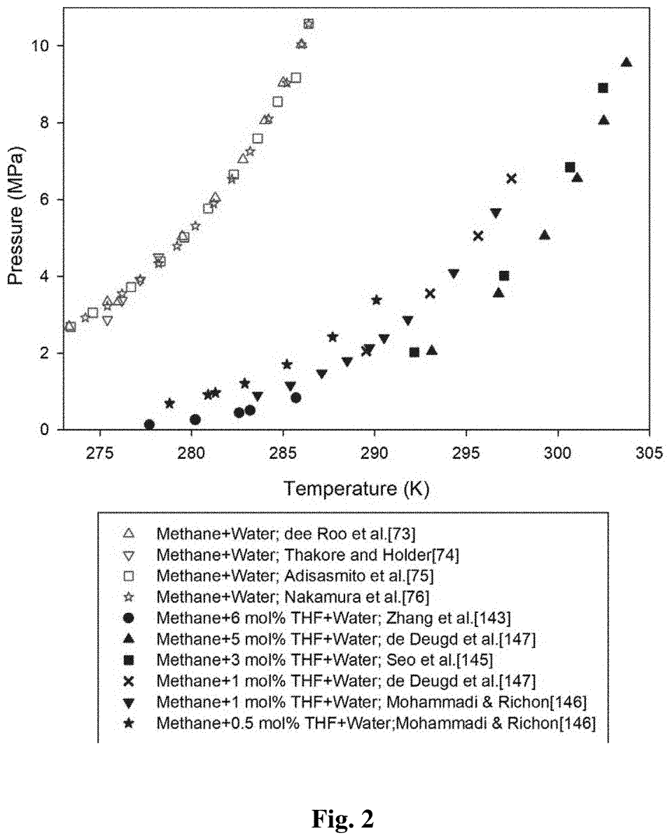

Pressure versus temperature equilibrium curves for the stability of natural gas hydrates using THF as a promoter are provided in Veluswamy et al., Applied Energy 2018; 216:262-285. (See, FIG. 2) The equilibrium curve (in temperature and pressure) shifts from the red to the blue with the addition of a promoter thereby allowing a higher possible temperature to form natural gas hydrates for a given pressure, or, a lower required pressure for hydrate formation for a given temperature. This curve also determines the conditions for maintaining the hydrate during transport and storage. The necessary temperature and pressure conditions for forming a structure II (sII) hydrate may exist at the seafloor. In such instances, a closed container does not need to sustain a pressure or temperature differential. If the temperature and pressure at the seafloor are not sufficient to form a structure II (sII) hydrate, then it is necessary to either increase the pressure, lower the temperature or a combination thereof. In such instances, the enclosed container for gas processing need only maintain the temperature and pressure differential.

The methods and systems described herein feature providing a thermodynamic promoter that results in formation of a natural gas clathrate hydrate having a structure II (sII) hydrate instead of a structure I (sI) hydrate. There is also a structure H (sH) hydrate that may exist, and comparisons of the sII to the sI hydrates apply similarly to the comparisons between the sII and sH hydrates there are some key advantages for forming a sII hydrate by adding a promoter when storing and transporting natural gas. First, it is possible to form the sII clathrate hydrate at a lower pressure and higher temperature than the corresponding sI hydrate. This is apparent from the equilibrium curve that delineates the boundary region at which a gas and water thermodynamically result in a binary fluid (gas and water) versus a hydrate. The equilibrium curve depicted in FIG. 2 is shifted to the right in the presence of the thermodynamic promoter. Relying on local temperature and pressure for the conversion of methane to an artificial temperature requires performing this conversion in shallower depths (lower pressure) at a higher temperature by adding the promoter in order to form a sII hydrate rather than a sI hydrate.

One advantage of providing a promoter to facilitate forming a structure II hydrate for the storage and transportation of methane (compared to forming a structure I hydrate), is the broader range of stability for sII hydrates, as shown in FIG. 2. At temperatures (up to 35° C.) it is possible to maintain an elevated pressure for the gas to remain as an sII hydrate. In contrast, at a temperature of 0° C., it is necessary to maintain a 3 MPa pressure to remain a hydrate. At higher temperatures the required pressure increases significantly to more than 10 MPA for a temperature of 12° C. A structure I hydrate can only maintain stability by controlling the temperature and presumably this is achieved by relying on a combination of two phenomena. First, the self-preservation effect is observed whereby the hydrate has a very low dissociation rate at a narrow temperature and pressure band. Second, the thermal mass can be exploited such that artificially formed hydrate is so large that it takes a long time to raise the temperature. Forming such a large structure of a buoyant material that must be anchored to the seafloor as it is being generated. These constraints are not present when a structure II hydrate is formed.

A consequence of this second phenomenon of the thermal mass adds a constraint to making very large structures (with the sI hydrate). This constraint is avoided by forming a sII hydrate thereby providing the opportunity to use a smaller container to store and transport the clathrate that is formed. It can become difficult to restrain a large structure as the contained hydrate may be less dense than seawater with a corresponding buoyancy force that is proportional to volume. As such, a smaller container may be used that is easier to control, maneuver, and restrain at the seafloor during production.

This formation step can be performed at the seafloor so that the local pressure and temperature correspond to a set of conditions for which sII hydrates form. In this instance, it is possible to operate at in situ conditions, i.e. such that temperature and pressure are in equilibrium with the conditions inside and outside the reaction container. FIG. 1 reference.

Alternatively, if the in situ conditions are such that sII hydrates will not form, it is necessary to either increase the pressure or decrease the temperature, with the former option typically the easier one to achieve, particularly below the sea surface.

### Carbon Dioxide Sequestered

In some instances, the methods and systems described herein separate natural gas from any impurities, particularly solids and gases, for instance, carbon dioxide (CO₂) prevalent in natural gas reservoirs. Carbon dioxide is inhibited from forming an sII clathrate hydrate. The temperature and pressure conditions allowing formation of an sII CO₂ hydrate are more unfavorable than the conditions for a sII methane hydrate. Specifically, the natural gas formation can be performed under a set of conditions in which sII CO₂ hydrates will not form. It is conjectured that the CO₂ molecule is too large to fit into a hydrate cage of structure II. In other words, substantially no CO₂ hydrate is formed in such conditions where a methane sII hydrate is formed. As such, the CO₂ does not participate in the conversion.

Ideally, the CO₂ passes through the system. One option is to sequester the exiting carbon dioxide gas and other non-desired compounds by injecting them back into the reservoir, i.e. back into the ground.

Depending upon pressure and temperature conditions, a small amount of CO₂ may form a hydrate in the natural gas hydrate formation stage, and some CO₂ and other impurities may also be entrained in the natural gas hydrate during its formation. In the latter case, some CO₂ may be sequestered while other CO₂ may be part of production gasses.

The methods and systems described herein for processing naturally formed methane clathrate hydrates are performed so that any CO₂ contained in the clathrate is captured and sequestered so that release of CO₂ into the atmosphere is minimized. In addition, methane gas that is released may be collected in a manner to collect and transport the captured gas.

### Surfactant

A surfactant may be provided in the methods and systems described herein such as, for instance, a dilute concentration of a micellular substance (one side polar and one side non-polar) to enhance the reaction. (See, e.g., Ando et al., Chemical Engineering Science 2012; 73:79-85) Suitable surfactants are well known in the art and may be provided in a dilute concentration (as small as parts per million to as much as 1-2%).

### Equilibrium of Reaction

As it relates to naturally occurring clathrates, FIGS. 1A and 1B depict the phase equilibrium curves (boundaries) for the formation of clathrate hydrates from methane and natural gas in terms of sea depth (proportional to pressure) and water temperature. As depicted in FIG. 1A, for a pure methane containing sample, the temperature is lower and pressure is higher for this embodiment. FIG. 1B shows that for natural gas, which comprises components other than methane, the temperature is shifted higher and the pressure to lower values for clathrate formation.

The methods and systems described herein are based in part upon the relationships demonstrated in FIG. 2. The conditions (depth and its corresponding pressure and temperature) are conducive to formation of a hydrate either structure I or structure II. The data in FIG. 1A, 1B relate to the conditions in the North Sea and Gulf of Mexico but can be modified to any location with appropriate knowledge of the temperature profile in the sea and the depth. If the local conditions are not conducive to implementing the processes described herein, then it is possible to achieve these conditions within the process by either increasing the pressure or decreasing the temperature or a combination of adjusting both the pressure and temperature. Either variable, i.e., pressure or temperature, may be manipulated predicated on the depth of the desired hydrocarbon or positioning of the disclosed apparatus. Therefore, collection and recovery may be performed at any depth below the surface of the sea.

The methods and systems described herein are effective for extracting methane from crude petroleum by converting the extracted methane to a methane clathrate hydrate. Once the methane clathrate hydrate is formed, the methane clathrate hydrate is isolated and delivered to a vessel for storage and/or shipment to a location. Once the methane clathrate hydrate is delivered to a user destination, the methane clathrate hydrate may be dissociated to yield the methane for the destination user's intended purposes.

The methods and systems described herein provide several advantages as those skilled in the art will understand. For example, the service water described herein may be sea water or another water source such as process water extracted from a reservoir. The water may have contaminants such as salt or other contaminants. When the methane hydrate clathrate is dissociated to form water and methane, the recovered water may be desalinated or purified of contaminants, if not completely processed for this purpose.

### Impurities

As described herein, impurities may be separated from natural gas, for example, solids and gases. Carbon dioxide (CO₂) may be prevalent in petroleum reservoirs. Without wishing to be limited by theory, carbon dioxide normally does not become entrained in a sII clathrate hydrate. The temperature and pressure conditions that allow for formation of a sII CO₂ clathrate hydrate are distinct from the conditions necessary to form a sII methane clathrate hydrate. By controlling the operating temperature and pressure of the formation step, it is possible to operate in a region where substantially no CO₂ clathrate hydrate is formed and yet methane hydrate is formed. Therefore, the CO₂ does not participate in the conversion. Under conditions controllable by the disclosed processes, CO₂ passes through the system. One non-limiting option is to sequester the exiting carbon dioxide gas and other non-desired compounds by injecting them back into the reservoir, i.e., back into the ground.

Other short chain hydrocarbons may be contained within natural gas clathrates, for example, ethane, propane, butane and isomers of propane and butane. These gases may have added commercial value. There are phase equilibrium curves (boundaries) for the formation of clathrate hydrates of pure methane, pure ethane, pure propane and pure butane. These non-methane hydrocarbons may be isolated from methane by adjusting the temperature and pressure of capture vessels described herein.

### Heat of Formation

The heat of formation of a sII hydrate is approximately three times the heat of formation necessary to form a sI methane clathrate hydrate. The corresponding heat of dissociation (i.e. the heat of necessary to liberate the sequestered methane) is the same as the corresponding heat of formation of the clathrate. This represents a difference in energy state between the hydrate and the corresponding gas and liquid. It is possible to utilize the difference in heat of formation when harvesting naturally occurring hydrates. There are three main production techniques for naturally occurring hydrates: thermal injection, chemical injection and depressurization. Regardless of the method used, it is necessary to supply energy equivalent to the heat of dissociation to recover the methane. When methane is then processed into a clathrate hydrate for storage and transportation, if a promoter is used to form a sII hydrate then three times as much energy is released when the heat of formation for the phase transition back to a hydrate. This energy from the heat of formation may be directed by way of one or more conventional methods, such as conduction through process equipment or forced convection via a heat transfer loop, in order to promote the production of natural gas from a reservoir of naturally formed hydrates.

For processing that may occur at the sea surface or near the sea surface, there are also three different primary sources for natural gas. First, the natural gas may come from production from a petroleum reservoir of natural gas and oil. During the conveyance of produced hydrocarbons from a subsea well to the surface, pressure falls, and the absorbed gas comes out of solution. In this scenario, the gas helps push the oil to the surface. At the surface, it is frequently difficult to utilize this gas, as the quantity may be too small to economically produce it. The gas may be processed by the processes described herein whereby by the gas is mixed with process water or injected sea water to form an sII hydrate, with the addition of a thermodynamic promoter. It may be necessary to increase the pressure or decrease the temperature (by conventional methods) in order for the reaction system to operate in conditions (temperature and pressure) such that a clathrate hydrate forms. There are a number of systems for which natural gas is currently flared or burned off. Often this is performed because the natural gas is mixed with undesirable impurities that cannot otherwise be disposed of. With this technique, the stream of natural gas that would otherwise be flared, may be processed accordingly. The system can be tuned by controlling gas and water flow rates and temperature and pressure so that the impurities do not form a hydrate and a set percentage (small fraction) of the natural gas passes through the system. The impurities and small fraction of natural gas are burned in order to generate electricity to either run the compressor to increase the pressure or a refrigerator/compressor to lower the temperature of the system. Another source is natural gas originating in a subterranean petroleum reservoir. Here the processing may either be on land or water (river, lake or sea). This includes processing of otherwise flared gas, such as in the Permian or Bakkan.

### Hydrate Transportation

The methods and systems described herein form a methane clathrate hydrate to facilitate transport to a location where it may be used. As such, it is important to maintain the hydrate in a stable form to prevent its dissociation to natural gas and water. This can be accomplished by maintaining the pressure and temperature to the ‘left’ of the equilibrium curve depicted in FIG. 2 for the corresponding hydrate structure (sI, sII or sH).

For processing at the seafloor, a pressure vessel may be transported to the surface via traditional methods. Some examples include by a remote-operated-vehicle, brought to the surface in conjunction with other maintenance operations, via ship-board crane, platform-based crane or on a dedicated pulley system.

The containers may be transported to a desired processing site by standard transportation methods, including being tugged along by a tug boat in the sea or loaded on a bulk carrier.

The desired processing site may be a location without a local fuel source and one for which conventional methods of natural gas supply (specifically LNG) may not be feasible. The shipping containers can be designed to deliver sufficient natural gas to the local population on an “as needed” basis. They may also provide storage to serve as a reserve or stockpile for contingencies. The apparatus disclosed herein can, therefore, be adapted to receive and use any size transport container.

As such, one aspect of the present disclosure relates to methods for providing a source of natural gas to a processor or user. The disclosed process features:
a) providing a stable sII methane clathrate hydrate; and
b) transporting the clathrate to a customer.

The stable sII methane clathrate hydrates can be transported to the customer by filling a suitable container at the point at which the clathrate is formed, for example, at the seafloor or on the sea surface. The container may have the ability to maintain a pressure differential with respect to the external pressure. The necessary minimum pressure is dependent upon the temperature, including temperatures as high as 35° C. for a structure II (sII) methane hydrate. Thus, it is possible to maintain a stable clathrate.

In one embodiment a pressurized container with no void volume can be filled on the seafloor where the disclosed processes and apparatuses form e clathrate hydrate. Once filled, the pressurized container may be transported to an end user, i.e., a processing or collection site or an end user.

### Dissociation to Natural Gas and Water

Once the methane clathrate hydrate is transported to the desired location it can be dissociated to form natural gas and water. The temperature and pressure of the hydrate must correspond to a condition where the water and gas phase is the preferred condition. i.e. on the ‘right’ of the equilibrium curve shown in FIG. 2. Either raising the temperature and/or lowering the pressure provides this result. The most likely way to achieve this is to allow the container to achieve equilibrium temperature and pressure. It is also necessary to add heat to the system for the heat of dissociation. The source of this heat can be a combination of one or more of the following: 1) undesired process heat that would otherwise be disposed into the environment or 2) the sea or other body of water which is at a lower temperature, or 3) radiation from the sun and 4) convection from external circulating air.

The process of dissociating methane clathrate hydrate to water and natural gas requires supplying a significant amount of heat. As discussed herein, using a naturally occurring recyclable heat sink that forms during methane clathrate hydrate formation may allow absorbing excess heat that would otherwise escape unused into the environment.

It is also possible to convert the hydrate to natural gas for subsequent processing to LNG. This may be performed at a Floating Production Storage and Offloading (FSPO) Vessel used for offshore oil extraction or an LNG Terminal. In this scenario, the natural gas clathrate hydrate is first converted (dissociated) to water and natural gas by a process as described herein. The source of heat for the hydrate dissociation may also include heat discharge from the FSPO or LNG terminal. The natural gas is then processed to LNG. The water recovered from the hydrate dissociation may be utilized in the FSPO or LNG terminal.

### Turning Now to the Figures

FIG. 3 is a plot of experimental results assembled by Veluswamy et al., Applied Energy 2018; 216:262-285). These data show the dependency of the methane/water system versus the methane/THF/water system on temperature and pressure. For the methane/water system the following references apply: ( [symbol] ) methane/water. (See, De Roo J L, et al., AIChE J 1983;29:651-7); ( [symbol] ) methane/water (see, Thakore et al., Ind Eng Chem Res 1987;26:462-9); (□) methane/water Adisasmito et al., J Chem Eng Data 1991;36:68-71); (⋆) methane/water Nakamura et al., Chem Eng Sci 2003;58:269-73). For the methane/THF/water system the following references apply: ( [symbol] ) methane/6 mol % THF/water (see, Zhanget al., J Chem Eng Data 2005;50:234-6); ( [symbol] )methane/5 mol % THF/water and ( [symbol] ) methane/1 mol % THF/water (see, De Deugdet al., AIChE J 2001;47:693-704)); (·) methane/3 mol % THF/water (see, Seo et al., Fluid Phase Equilib 2001;189:99-110); and (▾) methane/1 mol % THF/water and ( [symbol] ) methane/0.5 mol % THF/water (see, Mohammadi et al., Ind Eng Chem Res. 2009;48:7838-41).

FIG. 3 demonstrates that the equilibrium curve (in temperature and pressure) shifts from the red to the blue (open to solid symbols) when a promoter is provided thereby requiring a higher temperature to form natural gas hydrates for a given pressure, or, requiring a lower pressure for hydrate formation at a higher temperature. The curve also determines the conditions for maintaining a hydrate during transport and storage. When forming hydrate at the bottom of the sea it is possible to utilize the local temperature and pressure. It is relatively easy to increase pressure during processing using a suitable pressure chamber in order to shift the operating position to the left on the demonstrated curve in order, to produce conditions favoring natural gas hydrate formation.

A surfactant may be provided such as, for instance, a dilute concentration of a micellular substance (one side polar and one side non-polar) to enhance the reaction and reducing agglomeration of formed hydrate particules. (See, e.g., Ando et al., Chemical Engineering Science 2012; 73:79-85) Suitable surfactants are well known in the art and may be provided in a dilute concentration (as small as parts per million to as much as 1-2%).

FIG. 4 depicts a process for forming a structure II (sII) methane clathrate hydrate. A suitable apparatus may be juxtaposed to the point where natural gas is collected to be burned. The natural gas collected at this point may be converted into stable clathrates given the thermodynamic effects of the promoter to form sII clathrates.

In use feed line 200 is connected to reservoir 100. The reservoir may be either an underground, an undersea bed or well head or other source of natural gas such as that resulting from producing or processing fossil fuels. Crude oil is delivered through valve 110 by pump 111. The crude oil continues to heat exchanger 112 then into the bottom of vessel 101. By adjusting the temperature of the crude oil, dissolved gases become gradiently dissolved, i.e., as the dissolved gases that are proximal to the head space leave the crude oil and enter the head space, this concentration gradient causes more gas to percolate upwards. When the process is performed on a continuous basis rather than as a batch process, the gases in the head space may be diverted via line 201 by pump 112 to head exchanger 114 where the temperature of the gas may be adjusted. The gas then flows into chamber 102 where the gas is mixed with service water entering via line 204 and a promoter provided via line 208 to form a crude slurry or a pellet. The slurry or pellet is passed via pump 118 into nucleation chamber 103 where methane clathrate hydrate pellets are formed and undesirable gases such as CO₂ are liberated. Optionally, excess water is removed via line 205 and may be alternatively recycled for use via line 204. Liberated gases may be sent to the original reservoir, directed to an alternate reservoir or collected for entrainment via line 206. The clathrate hydrate formed thereby may then be delivered for processing or shipment via line 203. Vessel 103 can be adapted to introduce air or nitrogen as gases and water are removed to fill any void volume that is necessary. Methane depleted crude oil may be removed from vessel 101 via line 206 or alternatively recycled to stream 207, regardless of whether the process is conducted continuously, batch wise or incrementally.

In some instances, a surfactant may be added by modifying the configuration of vessels 102 or 103 to allow for introducing either an aqueous stream of surfactant or a solid surfactant readily soluble in existing water. When the service water is not recycled from stream 205 to stream 204, the surfactant can be contained in the service water stream.

The methods and systems described herein may be adapted or otherwise retrofitted to recover methane from volatile gases released from crude oil refining. The processes can receive volatile gases from any point in a refinery process, for example, from the first distillate of petroleum naphtha cut or from any gas processing step.

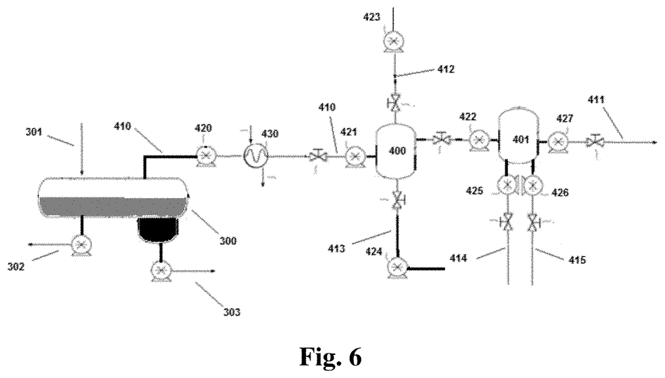

FIG. 6 depicts the retrofitting of the processes described herein to an oil refinery. In use, a cooled low volatile stream enters reflux vessel 300 via line 301. Reflux vessel 300 contains an upper gaseous layer (white), a lower condensate layer (gray) and sour water collector. The condensed layer, typically naphtha, may be recycled into the refinery via line 302 via a pump. The sour water may be removed via line 303 for disposal. Pump 420 delivers the gaseous layer into heat exchanger 430 via line 410 and pump 421 into vessel 400. Service water and a promoter are introduced by pump 424 via line 413 causing a clathrate slurry to form. The slurry is then transferred via pump 422 into vessel 401 where service water is removed, and a stable sII methane clathrate hydrate is formed. Excess promoter may be removed with the excess service water. Separated volatiles are removed via 412 utilizing pump 423. The stable methane clathrate hydrate can be removed by pump 427 via line 411.

### Exemplary Systems

### Process Design Steps Based on a Three-Tank System: Well-Head Entry.

Natural Gas or an oil/gas mixture rises up a tubing string from an underground reservoir to a well head at the seafloor. The gas/oil mixture may be mostly liquid at the original reservoir depth. At the point of entry to the well head and depending on any subsequent flow restrictor and the actual flow rate, the pressure may be lower than the reservoir but still greater than the local pressure at the seafloor. Similarly, the temperature will also fall, but still be much higher than the local water temperature. The fluid temperature and pressure will change because of the boiling and adiabatic expansion of the gas out of the oil as the pressure decreases while traveling up the wellbore. At this point in the process the disclosed apparatus can be fitted to the system to take advantage of the change in temperature and pressure.

Tank 2, NGCH Processor.

Once separated from the oil, the natural gas is pumped to Tank 2 through a gas line fitted with a flow meter and control valve to meter a precise quantity at a specific pressure. Concurrently, a precise amount of service water (and/or sea water) is pumped into Tank 2. Additionally, Tank 2 may be designed to operate as a batch process. In fact it may be desirable to have multiple (e.g. 3) smaller batch processing tanks, Tank 2a, Tank 2b, Tank 2c, etc. staggered in time to act as a semi-continuous process. This may reduce the buoyancy forces of the gas separator tank that might act as a holding tank to store gas in between tank fills. Having multiple smaller batch processing tanks also facilitates maintainability of the system. Tank 2 may be adapted to introduce a promoter and/or a dilute concentration of a surfactant into the process.

Described herein are systems and methods for extracting natural gas from crude oil and converting it to solid clathrate hydrates. The disclosed clathrates may be efficiently transported.

The methods described herein feature a first step of drilling a subsea well to extract natural gas from hydrocarbon reservoirs (oil and gas) below the seafloor. The configuration of the disclosed methods depends on the hydrocarbon makeup coming from the reservoir, the well may yield gas only, or a mix of gas and oil. In the case of a gas-oil mix, the oil is separated from the gas at the seafloor through a specially designed separator. The oil component is then piped to the sea surface and processed in the usual fashion. The natural gas component is cleaned of debris and piped into a gas/clathrate hydrate processing facility on the seafloor designed to form and place solid hydrates in large shipping containers for transporting to the sea surface.

The pressure in the oil or gas in the exit pipe just below the sea surface typically is much higher than the water pressure at the seafloor. In traditional systems, this pressure is utilized to move the oil and gas to the surface for processing. In the method described here, the pressure is not used for pushing the gas to the surface. As such, the gas expansion that occurs at the exit point from the seafloor, which may or may not involve a flow restrictor of some kind, can provide a means for power generation (electric or mechanical) through a turbine.

Other advantages which are obvious, and which are inherent to the disclosure will be evident to one skilled in the art. It will be understood that certain features and sub-combinations are of utility and may be employed without reference to other features and sub-combinations. This is contemplated by and is within the scope of the claims. Since many possible embodiments may be made of the disclosure without departing from the scope thereof, it is to be understood that all matter herein set forth or shown in the accompanying drawings is to be interpreted as illustrative and not in a limiting sense.

What is claimed is:

1. A method for extracting methane from crude oil comprising:
a) receiving crude oil into a first vessel in an amount sufficient to create a head space;
b) adjusting temperature and/or pressure of the vessel to produce separation of dissolved gases;
c) transferring the gases separated in step b) into a second vessel;
d) introducing water, optionally a thermodynamic promoter, and optionally a kinetic promoter into the second vessel;
e) adjusting the pressure and/or temperature to form a gas clathrate pellet; and
f) optionally transferring the sII gas clathrate hydrate to a storage vessel having one or more of the following characteristics:
i) neutrally or near-neutrally buoyant,
ii) strong enough to effectively contain the sII gas clathrate hydrate without substantial leaking or rupturing, and
iii) flexible to effectively resist substantial formation of a void volume.

2. The method according to claim 1, further comprising the step of:
g) transferring the processed crude oil from the first vessel to a container, pipeline, ship, or refinery for further processing.

3. The process according to claim 1 further comprising the steps of:
h) removing any unprocessed gas from the second vessel;
i) optionally transferring the unprocessed gas to a reservoir for sequestration and to maintain reservoir pressure; and
j) optionally processing the unprocessed gas for commercial purposes.

4. The method according to claim 3, wherein the unprocessed gas is carbon dioxide.

5. The method according to claim 3 wherein the unprocessed gas comprises one or more selected from the group consisting of ethane, propane, butane and mixtures thereof.

6. The method according to claim 1, wherein the promoter is selected from the group consisting of tetrahydrofuran, cyclopentane, 2,2-dimethylbutane, methylcyclohexane, neohexane, 2-methylcyclohexane, p-nacolone, isoamyl alcohol, tertiary-butyl methyl ether, and mixtures thereof.

7. The method according to claim 1, wherein in step d) the water is selected from the group consisting of fresh water, associated water and sea water and mixtures thereof.

8. A method for recovering methane from crude oil, comprising:
a) receiving crude oil into a first vessel in an amount sufficient to create a head space;
b) adjusting temperature and/or pressure of the first vessel to produce separation of any dissolved gas in the crude oil;
c) transferring the gas separated in b) into a second vessel;
d) introducing water, optionally a thermodynamic promoter into the second vessel to form a clathrate slurry and optionally a kinetic promoter into the second vessel;
e) removing any non-methane gas that does not form a clathrate;
f) optionally transferring the clathrate slurry to a third vessel;
g) adjusting the temperature and/or pressure to form a stable sII gas clathrate hydrate pellet; and
h) transferring the gas clathrate pellet to a fourth vessel, for storage and accumulation.

9. The method according to claim 8, further comprising the step of:
i) transferring the processed crude oil from the first vessel to a container, pipeline, ship, or refinery for further processing.

10. The method according to claim 8 further comprising the step of:
j) removing any unprocessed gas from the second vessel.

11. The method according to claim 10 wherein the unprocessed gas is carbon dioxide.

12. The method according to claim 10 wherein the unprocessed gas comprises one or more selected from the group consisting of ethane, propane, butane and mixtures thereof.

13. The method according to claim 8 wherein the promoter is selected from the group consisting of tetrahydrofuran, cyclopentane, 2,2-dimethylbutane, methylcyclohexane, neohexane, 2-methylcyclohexane, p-nacolone, isoamyl alcohol, tertiary-butyl methyl ether, and mixtures thereof.

14. A method for recovering methane at an oil refinery, comprising:
a) receiving volatile gases separated during a refinery process into a first vessel;
b) introducing water, optionally a thermodynamic promoter, and optionally a kinetic promoter such as a surfactant or amino acid into the second vessel;
c) adjusting temperature and/or pressure of the first vessel to produce formation of a clathrate slurry;
d) optionally removing any unprocessed gases;
e) optionally transferring the slurry to a second vessel;
f) adjusting the temperature and/or pressure to form a stable sII gas clathrate hydrate pellet; and
g) optionally transferring the sII gas clathrate hydrate to a storage vessel having one or more of the following characteristics:
i) neutrally or near-neutrally buoyant,
ii) strong enough to effectively contain the sII gas clathrate hydrate without substantial leaking or rupturing, and
iii) flexible to effectively resist substantial formation of void volume.

15. The method according to claim 14 wherein the unprocessed gas is carbon dioxide.

16. The method according to claim 14 wherein the unprocessed gas one or more selected from the group consisting of ethane, propane, butane and mixtures thereof.

17. The method according to claims 14 wherein the promoter is selected from the group consisting of tetrahydrofuran, cyclopentane, 2,2-dimethylbutane, methylcyclohexane, neohexane, 2-methylcyclohexane, p-nacolone, isoamyl alcohol, tertiary-butyl methyl ether, and mixtures thereof.

18. The method according to claim 14 wherein the storage vessel containing the stable sII methane clathrate hydrate is transported to a site for further processing into liquefied natural gas.

19. A method for extracting methane from a reservoir of natural gas hydrates currently existing in nature comprising:
a) receiving methane that has been dissociated from an existing natural gas hydrate reservoir into a first vessel;
b) introducing water, optionally a thermodynamic promoter into a second vessel to form a clathrate slurry and optionally a kinetic promoter into the second vessel;
c) adjusting the temperature and/or pressure to form a stable sII gas clathrate hydrate pellet; d) removing any non-methane gas that does not form a stable sII gas clathrate hydrate pellet;
d) optionally transferring the a stable sII gas clathrate hydrate pellet to a second vessel;
e) optionally transferring the stable sII gas clathrate hydrate pellet to a storage vessel having one or more of the following characteristics:
a) neutrally or near-neutrally buoyant,
b) strong enough to effectively contain the stable sII gas clathrate hydrate pellet without substantial leaking or rupturing, and
c) flexible to effectively resist substantial formation of void volume; and
f) directing heat generated from production of the stable sII gas clathrate hydrate pellet to a natural gas hydrate reservoir.

20. The method of claim 14 further comprising:
h) transferring the storage vessels to a storage facility.
